(19) United States
(12) Patent Application Publication
(10) Pub. No.: US 2007/0273817 A1
(43) Pub. Date: Nov. 29, 2007

(54) Optical Compensator Film for Lcd Via Multilayer Structure

(75) Inventors: Ho-jun Lee, Daejeon (KR); Dong-ryul Kim, Daejeon (KR); Sang-uk Ryu, Daejeon (KR); Hee-jung Kim, Daejeon (KR); Gi-cheul Kim, Daejeon (KR)

Correspondence Address: MCKENNA LONG & ALDRIDGE LLP, 1900 K STREET, NW, WASHINGTON, DC, 20006, US

(73) Assignee: LG Chem, Ltd., Seoul, Youngdungpo-gu (KR)

(21) Appl. No.: 10/593,621

(22) PCT Filed: Sep. 23, 2005
(86) PCT No.: PCT/KR05/03164

§ 371 Date: May 18, 2007

(30) Foreign Application Priority Data
Sep. 24, 2004 (KR) 10-2004-0076981

(51) Int. Cl. G02F 1/1335

(52) U.S. Cl. 349/119

(57) ABSTRACT

The present invention relates to a compensator film having multilayer structure including both negative optical retardation in thickness direction and optical retardation in in-plane direction at the same time to improve wide view angle, in which a polymer base layer provides optical retardation in in-plane direction, organic or organic/inorganic hybrid protective layer formed on the base layer contributes to the improvement of mechanical properties such as curl prevention and polymer orientation of coating layer, and the out-most layer, a polymer coating layer, endows optical retardation in thickness direction. The multilayer, in which each layer is individually functioning, enables the preparation of a compensator film having proper optical retardation.

### TECHNICAL FIELD

The present invention relates to an optical compensator film for LCD designed to improve wide view angle, more precisely, an optical compensator film having multilayer structure with negative optical retardation produced by coating a polymer film having low optical retardation with a polymer solution having high optical retardation in the out of plane direction and then volatilizing a solvent used.

### BACKGROUND ART

According to the scale-up of LCD, various optical retardation compensator films are urgently required to secure wide view angle. As shown in mathematical formula 1, optical retardation is defined as birefringence and the thickness of film. In formula 1, when (nₓ+n_{y})/2>n_{z}, Rₜₕ is negative value, and when (nₓ+n_{y})/2<n_{z}, Rₜₕ is positive value.

$${R}_{th} = ( {n}_{z} - \frac{{n}_{x} + {n}_{y}}{2} ) \times d \qquad [ Mathematical Formula 1 ]$$

Wherein, Rₜₕ indicates optical retardation in out of plane direction, nₓ and n_{y} indicate reflective index in in-plane direction of a film, n_{z} indicates reflective index in out of plane direction of a film and d indicates the film thickness.

Color and brightness of the screen of LCD varies with view angles owing to the high level of birefringence of liquid crystal molecule. In general, most liquid crystal molecules have positive optical retardation in out of plane direction of display, which means they need compensator films having negative optical retardation. Compensator films with negative optical retardation have been tried in various manners so far, but the control of optical retardation is very difficult and so the product is not competitive in the price. One of the key points for a satisfactory compensator film is easy control of its birefringence. Birefringence depends on not only the fundamental character of a subject but also the orientation of molecules in film. The orientation of molecules is attributed to the compulsory force given from the outside or innate character of a subject. The orientation of molecules by force includes uniaxial or biaxial stretching of polymer film. Most of the compensator films being in use are prepared by such stretching methods. However, the preparation of compensator films with optical retardations by using stretching methods has problems of difficulty in control of birefringence and reducing the thickness of film, so the product has uneven optical retardation. Thus, an expecting alternative is to coat the surface of a film with liquid crystal molecules for a compensator film. It has also problems, though, of high price of liquid crystal molecules and insufficient adhesive force resulted from weak compatibility to polymer in-plane, making the coated liquid crystal layer to be peeled easily from the surface of a polymer. In addition, high level of birefringence makes the control of optical retardation very difficult because even slight changes of orientation and thickness of liquid crystal result in the huge difference of optical retardation of a whole compensator film.

In most polymers, molecular chain is optical axis to show a unique birefringence of materials. And according to a preparation method for a film, birefringence of a final film product can be quite different from the original birefringence provided by a copolymer molecule. When a film is prepared by melt-extruding, the degree of orientation of a polymer chain depends on force given from outside. In the meantime, when a film is prepared by the method of solution casting, optical retardation in in-plane direction is not much changed because the degree of orientation of polymer chains is very low at this time. Therefore, the optical retardation can be obtained by either uniaxial or biaxial stretching inducing orientation of polymer chains in in-plane direction of a film. When the thickness of a film is reduced to the length of molecular level, the stretching effect of the film is increased, and so the orientation of polymer chains is maximized, resulting in high birefringence. The optical retardation of a film is generated toward two directions; in-plane direction and out of plane direction. The optical retardation in in-plane direction is defined by the difference of reflective indices crossing on film and the thickness of a film, suggesting that the resulting value can be completely different from that of original birefringence possessed by a polymer molecule.

Japanese Patent Publication No. JP2001-194668 describes that an optical retardation compensator film in out of plane direction is prepared by cross-layering of polycarbonate film having optical retardation in in-plane direction by uniaxial stretching. This method requires a very complicated layering process, in particular, optic axis has to be crossed while films are layered. U.S. Pat. No. 5,043,413 introduced a preparation method for polyarylate having low level of birefringence in in-plane direction, in which solution casting with polyarylate is performed to produce a film, and then birefringences are compared after stretching is completed. Upon completion of stretching, polyarylate film having low level of birefringence of up to 25.7×10⁻⁵ proceeds to polymerization. So, stretching generates birefringence in in-plane direction, which is not proper for C type compensator film asking birefringence in out of plane direction. U.S. Pat. No. 5,285,303 proposed a method to prepare an optical compensator film with wide view angle using polyacrylate film by uniaxial stretching which provides optical retardation in out of plane direction by contraction in stretching direction and right angle direction. In general, optical retardation of liquid crystal is in the range of 100˜400 nm. To compensate the optical retardation, reverse optical retardation in the range of −100˜−400 nm is required. But, stretching only reduces film thickness and does not contribute to the control of optical retardation. Japanese Patent Application No. JP 1999-95208 describes a preparation method for an optical retardation compensator film by stretching of various polymer films. And at this time, polycarbonate, polyarylate and polysulfone films are used. The stretching of polymer film to secure the optical retardation in out of plane direction necessarily affects the optical retardation in in-plane direction, indicating that simultaneous control of optical retardations in both out of plane direction and in-plane direction is needed. As a matter of fact, it is almost impossible to regulate both optical retardations in out of plane direction and in in-plane direction by stretching.

### DISCLOSURE OF INVENTION

In order to solve the above problems, the present invention provides a preparation method for a compensator film having multilayer structure, in which two different optical retardations, that is optical retardation in out of plane direction and optical retardation in in-plane direction, can be independently regulated, providing easier way than using the conventional biaxial stretching.

The object of the present invention can be achieved by the following embodiments of the present invention.

To achieve the above object, the present invention provides a compensator film for LCD containing a polymer base layer; a protective layer formed by coating at least a side of the polymer base layer with organic or organic/inorganic hybrid composition; and a polymer coating layer having negative optical retardation in out of plane direction defined as the following formula 1, formed on upper part of the protective layer placed on the polymer base layer.

$${R}_{th} = ( {n}_{z} - \frac{{n}_{x} + {n}_{y}}{2} ) \times d \qquad [ Mathematical Formula 1 ]$$

Wherein, Rₜₕ, indicates the optical retardation in out of plane direction, nₓ and n_{y} indicate reflective indices in in-plane direction of film, n_{z} indicates a reflective index in out of plane direction of film and d indicates a film thickness.

The polymer base layer is 10 μm-300 μm in thickness and a transparent polymer selected from a group consisting of polycarbonate, triacethylcellulose, cyclo-olefin polymer, cyclo-olefin copolymer and (meth)acrylate polymer or a film having multilayer of one or more transparent polymers. It is preferred for the polymer base layer to have negative optical retardation in out of plane direction, presented in the above formula 1, which is preferably up to 200 nm.

A film used as the polymer base layer of the invention is treated by a method selected from a group consisting of corona treatment, acid/base treatment and UV treatment.

The organic protective layer can be selected from a group consisting of UV hardened or heat hardened acrylate polymer, methacrylate polymer and acrylate/methacrylate copolymer.

The organic/inorganic hybrid composition can be a mixture of organic silane, metal alkoxide and filler.

The organic silane is included in amount of 20-99.99 weight part based on 100 weight part of the whole composition, and the metal alkoxide is included in amount of 20˜70 weight part based on 100 weight part of the whole composition.

A composition used to prepare the organic/inorganic hybrid protective layer is a resin composition that can be hardened at room temperature and by heat, and can include hardening catalyst and acrylic resin selected from a group consisting of acrylate oligomer, methacrylate oligomer, acrylate/methacrylate oligomer and silica-dispersion oligomer solution of organic silane prepared by partial-hydrolysis of hydrolyzing organic silane among colloidal silica dispersed in organic solvent, water or the mixture thereof.

The organic/inorganic hybrid composition can also contain silicone coupling agent that can be hardened by UV or heat, silicon oligomer solution having at least two acrylate functional groups resulted from hydrolysis of oil colloid silica, acrylate oligomer solution, acrylate monomer solution and photo-initiator and/or a thermal initiator.

The organic or organic/inorganic hybrid protective layer is preferably 0.01 μm-10 μm in thickness. Hereinafter, the organic or organic/inorganic hybrid layer is referred as protective layer.

The polymer coating layer of the above can be a polyacrylate coated with up to 10 μm thick layer and having negative optical retardation of at least 10 nm, represented by the formula 1.

The compensator film mentioned above is 20˜300 μm in thickness and has negative optical retardation in out of plane direction, which is at least 10 nm, represented by formula 1.

The polyarylate is an aromatic linear polyester resin prepared by polycondensation of aromatic diol and aromatic dicarboxylic acid, whose molecular weight is heavier than that of entanglement of a polymer, which is preferably at least 20,000 g/mol.

The present invention also provides a LCD containing the compensator film.

The LCD of the invention is selected from a group consisting of vertical alignment LCD, twist nematic LCD and sheet switching LCD, and among these, vertical alignment LCD is more preferred.

Hereinafter, the present invention is described in detail.

The present invention provides a compensator film having multilayer structure, prepared by coating a polymer film with another polymer having high optical retardation in out of plane direction, for improving wide view angles.

The compensator film having multilayer structure, as shown in FIG. 1, is composed of a polymer base layer (10), a protective layer (20) and a polymer coating layer (30), and has optical retardations. More precisely, the film is prepared by creating a protective layer (20) on at least one side of the polymer base layer (10) and loading a polymer coating layer (30) on the protective layer. The film might have another multilayer structure, as shown in FIG. 2, in which one side of the polymer base layer (10) is coated with surface modified layer (40) to provide interfacial adhesive force, and then a protective layer (20) and a polymer coating layer (30) are placed thereon serially by a regular thickness. Besides, a film with multilayer structure containing a polymer base layer (10), a protective layer (20) on the base layer, and a polymer coating layer (30) is also produced, which is then covered again with hard coating layer (20) for the protection of the surface, as shown in FIG. 3. Another multilayer structure, as shown in FIG. 4, is possible, in which the structure of FIG. 2 is once again loaded with hard coating layer on its surface. It is preferable to produce a compensator film with multilayer structure by lamination of two individual films each having multilayer structure, as shown in FIG. 5, rather than by serial coating layer by layer.

The compensator film having multilayer structure of the present invention, unlike the conventional compensator films, is characterized by the distinction of functions of each layer and the maximization of efficiency to realize multilayer structure from optical retardations in out of plane direction. Precisely, as shown in FIG. 2, among four different layers, the bottom layer, a polymer base layer (10) endows intrafacial optical retardation, the second layer, a surface modified layer (40) improves adhesive force between the two layers of a polymer base layer (10) and a protective layer (20), and the third layer, a protective layer (20) plays a role in enhancement of mechanical properties including curl prevention and polymer orientation. The last upper-most layer, a polymer coating layer (30), endows optical retardation in out of plane direction. And the combination of all the layers having different functions results in a compensator film having proper optical retardation.

The polymer base layer (10) is a transparent polymer base layer with low or without optical retardation in out of plane direction, which can be prepared by extrusion or solvent casting. The polymer base layer is composed of a single polymer or a blend of at least two polymers or a polymer mixture including organic or inorganic additives. The polymers that can be used as a base layer regardless of glass transition temperature are exemplified by polycarbonate, triacethylcellulose, cyclo-olefin polymer, cyclo-olefin copolymer, (metha)acrylate resin, etc. The polymer base is a film having a thickness of 50˜300 μm, which is prepared by solution casting or melting extrusion. To minimize the transformation of a film according to temperature change, annealing is preferably performed at around glass transition temperature. After annealing, the surface of the polymer base film is treated by primer coating or with corona, oxygen or carbon dioxide plasma, UV-ozone, reactant gas, ion beam etc, to improve coating property and adhesive force.

It is more preferred for the polymer base layer to have intrafacial optical retardation at least +20 nm, as indicated in the below mathematical formula 2.
Rᵢₙ=(nₓ−n_{y})×d [Mathematical Formula 2]

Wherein, Rᵢₙ indicates intrafacial optical retardation of a film, nₓ indicates reflection in optical axis direction of a film, n_{y} indicates reflection at a right angle to optical axis of a film and d indicates the thickness of a film.

The protective layer (20) can be either organic or inorganic/organic hybrid protective layer, which not only improves mechanical strength of a film and adhesive force between the base layer and the coating layer but also affects orientation of polymer layer which would cover the protective layer because its surface properties are apt to be changed by the degree of hardening. The protective layer prepared by the form of sol solution is loaded on the polymer base layer by spin coating, roller coating, bar coating, deep coating, gravure coating or spray coating, which is then hardened by heat hardening, UV hardening, infrared hardening or high frequency heating. The preferable thickness of the protective layer after hardening is 0.01˜10 μm, and 0.5˜5 μm is more preferred. The organic protective layer can be selected from a group consisting of UV hardened or heat hardened acrylate polymer, methacrylate polymer and acrylate/methacrylate copolymer.

The organic/inorganic hybrid composition is prepared by mixing organic silane, metal alkoxide and filler, in which proper solvent and polymerization catalyst as well as other additives can be additionally included.

The protective layer is used to prevent the invasion of organic solvent in polymer coating layer (30) into the polymer base layer, and can be a crosslinked compound by sol-gel or others. For example, first, the composition for the protective layer can be acrylate and/or methacrylate polymer (U.S. Pat. No. 4,605,465) represented by the formula of (CH₂═CRCOO)ₙR¹ which is UV hardened or heat hardened (In this formula, R is hydrogen atom or methyl group, R¹ is organic compound, and n is at least 2). Second, the composition is produced from the mixture of organic silane silica-dispersed oligomer solution prepared by partial hydrolysis of hydrolyzed organic silane represented by R²ₙSiX₄₋ₙ (Wherein, R² is C₁₋₉ monoatomic hydrocarbon radical or phenyl group which is homo- or hetero-substituted or not substituted, n is one of integers from 0 to 3 and X is hydrolyzed functional group), that is a resin composition for coating having excellent storage stability and being hardened by either at room temperature or by heat from colloidal silica in organic solvent, water or the mixture of the two; acrylate and/or methacrylate copolymer acrylic resin represented by the formula of CH₂═CR³(COOR⁴) (Wherein, R³ is hydrogen atom or methyl group, R⁴ is organic compound); and a hardening catalyst (Korean Patent Publication No. 1997-707487). Third, the composition can be prepared from the mixture including silicone oligomer solution having two or more acrylate functional groups resulted from hydrolysis of silicone coupling agent, which can be hardened by either UV or heat, and oil colloid silica; acrylate oligomer solution; acrylate monomer solution; and photo-initiator and/or thermal initiator (Korean Patent Publication No. 2002-0020599).

The polymer coating layer (30) endowing reflective index in out of plane direction is a film prepared by the steps of dissolving a polymer in organic solvent at the concentration of up to 10 weight %, placing the solution on the surface of a polymer for coating and vaporizing solvent therein. The polymer applied to the coating layer has to have high level of negative birefringence and exemplified by polyarylate, cyclo-olefin polymer and polyimide, etc. When the polymer is prepared as a film having 50˜100 μm thickness by solvent casting, it turns out to be not proper as a compensator film since optical retardation of the film becomes too high with that thickness. Thus, to lower optical retardation, an additive has to be used or film production process has to be modified. However, the present invention proposed that even a polymer with high level of birefringence can be used, by being coated with 0.01˜10 μm thick thin film, as a optical retardation compensator film without stretching. The entire optical retardation of the whole multilayer film can be regulated by regulating the thickness of coating. In the meantime, optical retardation can also be affected by volatile conditions of a solvent.

In the present invention, polyarylate is used as a polymer coating layer. And possible polyarylate for the invention is represented by the following formula 1.

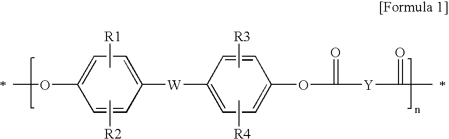

Wherein, R1, R2, R3 and R4 are independently hydrogen, C₁˜C₁₂ alkyl, C₆˜C₁₂ arylalkyl, C₆˜C₁₂ aryl, C₁˜C₁₂ nitrile, C₁˜C₁₂ alkoxy, C₁˜C₁₂ acyl or halogen, W is C₁˜C₃₀ alkylidene, C₂˜C₃₀ alkylene, C₃˜C₃₀ cycloalkylidene, C₃˜C₃₀ cycloalkene or C₁˜C₃₀ phenyl-substituted alkylene, fluorene, oxygen, sulfur, sulfoxide, sulfone or single bond. The applicable aromatic dihydroxy compound is bis(4-hydroxyaryl)alkane, more specifically bis(4-hydroxyphenyl)methane, 2,2-bis(4-hydroxyphenyl)propane (BPA), 2,2-bis(4-hydroxyphenyl)ethane, 2,2-bis(4-hydroxy-3-methylphenyl)propane, 2,2-bis(4-hydroxyphenyl)heptane, 2,2-bis(4-hydroxy-3,5-dichlorophenyl)propane, 2,2-bis(4-hydroxy-3,5-dibromophenyl)propane, bis(4-hydroxyphenyl)phenylmethane, 4,4-dihydroxyphenyl-1,1-m-diisopropylbenzene, 4,4-dihydroxyphenyl-9,9-fluorene, 2,2-bis(4-hydroxyphenyl)fluorine (BHPF), 9,9-bis(3,5-dimethyl-4-hydroxyphenyl)fluorene (BDMPF) or 9,9-bis(3,5-dibromo-4-hydroxyphenyl)fluorine (BFBPF), and a mixture of at least two of them can also be used.

In addition, bis(hydroxyaryl)cyclo alkanes are also applicable, and specifically 1,1-bis(4,4-hydroxyphenyl)cyclopentane, 1,1-bis(4,4-hydroxyphenyl)cyclohexane, 1-methyl-1-(4-hydroxyphenyl)-4-(dimethyl-4-hydroxyphenyl)cyclohexane, 4-{1-[3-(4-hydroxyphenyl)-4-methylcyclohexyl]-1-methylethyl}phenol, 4,4-[1-methyl-4-(1-methylethyl)-1,3-cyclohexylidyl]bisphenol, 2,2,2,2-tetrahydro-3,3,3,3-tetramethyl-1,1-spirobis-[1H]-indene-6,6-diol, or a mixture of at least two of them can be used.

Dihydroxy diarylether is exemplified by bis(4-hydroxyphenyl)ether, bis(4-hydroxy-3,5-dichlorophenyl)ether and 4,4-dihydroxy-3,3-dimethylphenylether; dihydroxydiarylsulphide is exemplified by 4,4-dihydroxy diphenylsulphide and 4,4-dihydroxy-3,3-dimethyldiphenylsulphide; dihydroxy diarylsulphoxide is exemplified by 4,4-dihydroxy diphenylsulphoxide and 4,4-dihydroxy-3,3-dimethyldiphenylsulphoxide; dihydroxy siarylsulphonate is exemplified by 4,4-dihydroxy diphenylsulphone and 4,4-dihydroxy diphenylsulphone and 4,4-dihydroxy-3,3-dimethyldiphenylsulphone, etc, and each of them or a mixture of at least two of them can be used as aromatic dihydroxy compound.

In the above formula, —OOCYCO— can be one of terephthalic acid, isophthalic acid, dibenzoic acid or naphthalene dicarboxylic acid in which aromatic group can be substituted with a substituent selected from a group consisting of C₁˜C₈ alkyl, aryl, alkylaryl and halogen, and/or a mixture comprising at least two of the above.

In particular, polyarylate containing the following repeating unit is preferably used in the present invention, but the structure of the repeating unit is not always limited to the following formula.

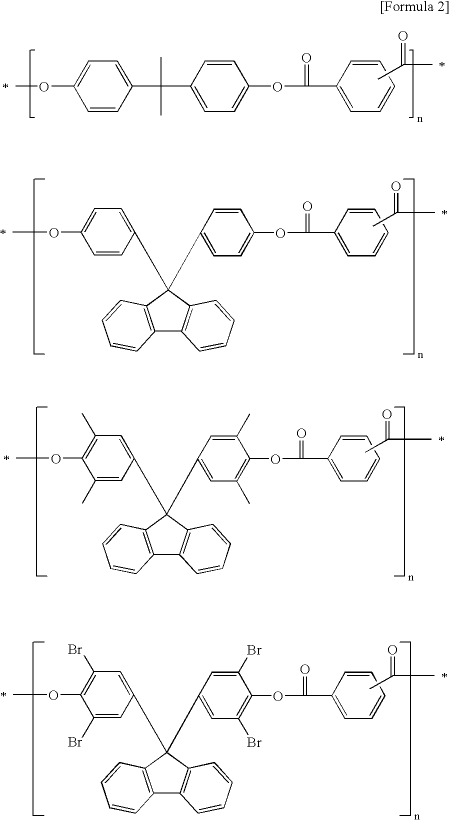

### BRIEF DESCRIPTION OF THE DRAWINGS

FIGS. 1-5 are sectional drawings showing the sections of compensator films prepared according to the preferred embodiments of the present invention.

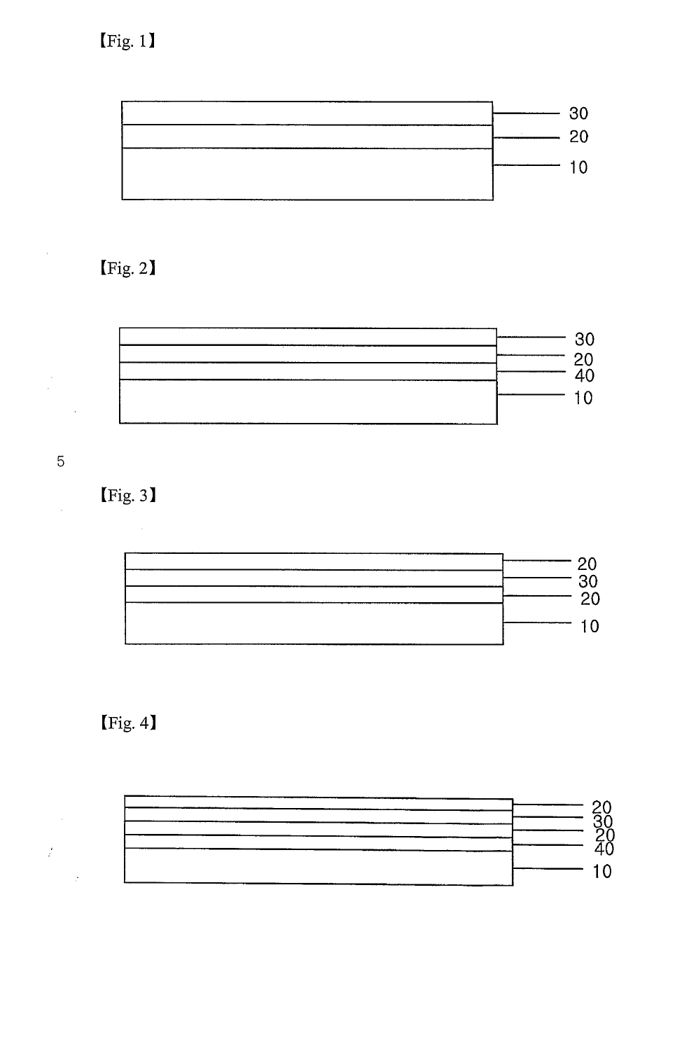

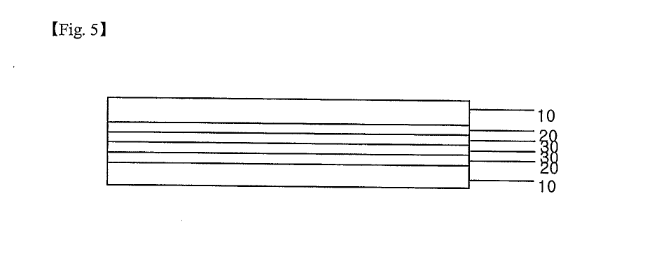

10: polymer base layer
20: organic or organic/inorganic hybrid protective layer
30: polymer coating layer
40: surface modified layer

### BEST MODE FOR CARRYING OUT THE INVENTION

Practical and presently preferred embodiments of the present invention are illustrative as shown in the following Examples. However, it will be appreciated that those skilled in the art, on consideration of this disclosure, may make modifications and improvements within the spirit and scope of the present invention. And, the synthesis of the mentioned polyarylate is not always limited to the examples of the invention.

### SYNTHETIC EXAMPLE

To a reactor equipped with a stirrer were added 9.93 g of 2,2-bis(4-hydroxyphenyl)propane, 0.066 g of t-butylphenol, 3.85 g of NaOH and 92 g of distilled water, followed by stirring for dissolving. Then, the temperature of the reactor was maintained as 20° C., and 0.48 g of benzyltriethylammonium bromide and 6.5 g of methylenechloride were added, followed by hard stirring. In the meantime, separately with the above reaction solution, 8.84 g of aromatic carboxylic acid mixture comprising equal amount of isophthalic acid and terephthalic acid was dissolved in 106 g of methylenechloride. The solution was added to the alkali aqueous solution prepared in advance. After one hour of polymerization, acetic acid was added to terminate the reaction. As much methylenechloride and twice as much distilled water as the volume of the total reaction solution were added, followed by washing several times. Washing was repeated until the conductivity of the solution was up to 50 μs/cm, then methanol was added to the solution to precipitate polymer. The resulting dihydroxy monomer of polyarylate has 100 mol % of 2,2-bis(4-hydroxyphenyl)propane (BPA), glass transition temperature of 200° C. and molecular weight of 98,000 g/mol.

### EXAMPLE 1-EXAMPLE 5

Polycarbonate film having thickness of 100 μm and optical retardation of −59 nm, prepared by organic solvent casting, was heat-treated in 150° C. convection oven for one minute to eliminate residual stress, being ready to be used as a polymer base. The polycarbonate base was coated with organic silane silica-dispersed acrylate oligomer solution, as an organic/inorganic hybrid composition, followed by heat-hardening. The thickness of the organic/inorganic hybrid buffer layer, measured by alpha stepper, was 1.5 μm. The polyarylate polymerized with 100 mol % of bisphenol A in the above Synthetic Example was added to dichloroethane solvent by 5 weight %, resulting in the polyarylate solution. The polycarbonate base pre-coated with organic/inorganic hybrid protective layer was coated with the 5 weight % polyarylate solution in buffer for thickness control, then coating with a proper thickness, as shown in Table 1, was completed. The solvent was dried for one hour and then the remaining solvent was completely dried again for 5 minutes in 90° C. oven, resulting in a compensator film. The thickness of the coating layer was measured by alpha stepper. The optical properties of the base layer and the multilayer film were investigated with measuring intrafacial optical retardation and optical retardation in out of plane direction. Optical retardation in out of plane direction of a film was calculated by the following mathematical formula, in which optical retardations at 50 degree angle and −50 degree angle of light were measured for the calculation.

$${R}_{th} = \frac{( {R}_{θ} - {R}_{{in}_{( θ = 0 )}} ) \times cos θ}{{sin}^{2} θ} \qquad [ Mathematical Formula 3 ]$$

Wherein, Rₜₕ indicates optical retardation in out of plane direction, R_{θ} indicates optical retardation at θ, Rᵢₙ indicates intrafacial optical retardation when θ=0 and θ is angle of the surface of a film and light.

In the mathematical formula 1, Rₜₕ is defined by different reflections at each direction. Mathematical formula 3 shows the relational expression calculating Rₜₕ, and in fact, most Rₜₕ can be calculated from transmittance data by mathematical formula 3. The results of the embodiments of the invention were also calculated by mathematical formula 3.

### COMPARATIVE EXAMPLE 1

Polycarbonate film was prepared by the same manner as described in Example 1 except that only polycarbonate base was used for the preparation.

### COMPARATIVE EXAMPLE 2

The film was prepared by the same manner as described in Example 1 except that polycarbonate base was coated with organic/inorganic hybrid composition, to produce a compensator film with organic/inorganic hybrid coating layer.

### COMPARATIVE EXAMPLE 3

The film was prepared by the same manner as described in Example 1 except that polycarbonate base was coated with polyarylate polymerized with 100 mol % of bisphenol A to produce a compensator film with polymer coating layer.

TABLE 1

| | Thickness of | | | |
|---|---|---|---|---|
| | organic- | | | |
| | inorganic hybrid | Thickness of | | |
| | coating layer | polymer coating | Rᵢₙ | Total Rₜₕ |
| | (μm) | layer (μm) | (nm) | (nm) |
| Comparative | 0 | 0 | 2 | −59 |
| Example 1 | | | | |
| Comparative | 1.5 | 0 | 2 | −60 |
| Example 2 | | | | |
| Comparative | 0 | 2 | 2 | −65 |
| Example 3 | | | | |
| Example 1 | 1.5 | 0.5 | 2 | −84.6 |
| Example 2 | 1.5 | 1.1 | 2 | −103 |
| Example 3 | 1.5 | 2.2 | 2 | −123 |
| Example 4 | 1.5 | 13 | 2 | −396 |
| Example 5 | 2 | 2.2 | 2 | −123 |

Glass transition temperature and molecular weight of the polymer of the coating layer were measured by RSA III of Leomatrix and GPC of Agilent. As a result, glass transition temperature was 200° C., and molecular weight was 98,000 g/mol. Compensator films prepared in Examples 1˜5 were not crooked on flat floor. As shown in Table 1, the compensator films had bigger optical retardations in out of plane direction than that of the film prepared from only polycarbonate film of Comparative Example 1. Another film prepared in Comparative Example 3, which was produced without using organic/inorganic hybrid protective layer, showed curl as a solvent in polymer coating layer was vaporized and distortion as a solvent attacked the base. From the investigation of optical properties was confirmed that optical retardation was remarkably decreased when a protective layer was not placed.

### EXAMPLE 6

A compensator film was prepared by the same manner as described in Example 1 except that uniaxial stretching triacetyl cellulose base was used instead of polycarbonate base. Optical properties of the compensator film provided by Example 6 are shown in Table 2.

TABLE 2

| | Thickness of | | | |
|---|---|---|---|---|
| | organic- | | | |
| | inorganic hybrid | Thickness of | | |
| | coating layer | polymer coating | Rᵢₙ | Total Rₜₕ |
| | (μm) | layer (μm) | (nm) | (nm) |
| Comparative | 0 | 0 | 33 | −142 |
| Example 4 | | | | |
| Comparative | 1.0 | 0 | 37 | −150 |
| Example 5 | | | | |
| Comparative | 1.0 | 0.5 | 37 | −206 |
| Example 6 | | | | |

Polymer of the base layer has a big intrafacial optical retardation (Rᵢₙ), resulted from uniaxial stretching in machine direction, and double coating with organic/inorganic hybrid composition and polyarylate endows optical retardation in out of plane direction in addition to intrafacial optical retardation to a compensator film. Since both optical retardations in out of plane direction and in-plane direction exist together but can be regulated separately, the film can be used as type A compensator film and at the same time type C compensator film. When solvent is vaporized from polymer solution, orientation of polymer changes according to the properties of base, causing different optical retardation in out of plane direction from the original one. Optical retardation is bigger with the increase of inorganic substance content in the surface and high polymer-affinity.

### EXAMPLE 7˜EXAMPLE 9

Examples 7˜9 showed the effects of different solvents on the preparation of a film with polyarylate by solution casting. In those Examples, base was polycarbonate coated with 1.5 μm thick inorganic/organic hybrid protective layer, and the content of polyarylate polymer was 5 weight % for every possible solvents. The production procedure of a film and measurement of optical retardation were the same as described in Example 1.

TABLE 3

| | Example 7 | Example 8 | Example 1 | Example 9 |
|---|---|---|---|---|
| Solvent | MC | THF | DCE | DOX |
| b.p (° C.) | 40 | 66 | 83.5 | 101 |
| Coating | 1.5 | 0.5 | 0.5 | 4.5 |
| thickness (μm) | | | | |
| Rᵢₙ (nm) | 2 | 2 | 2 | 2 |
| Total Rₜₕ (nm) | −89.3 | −87.7 | −84.6 | −90.5 |
| Coating layer | −19.5 | −55.4 | −16.4 | −6.8 |
| Rₜₕ (nm)/μm | | | | |

MC: methyl chloride
THF: tetrahydrofuran
DCE: dichloroethane
DOX: dioxane

### EXAMPLE 10 AND EXAMPLE 11

Compensator films were prepared by the same manner as described in Example 1, except that polyarylate having bisphenol A content of 10 mol %, molecular weight of 40,000 g/mol and glass transition temperature of 300° C. was used, followed by measurement of optical retardation.

TABLE 4

| | Thickness of | | | |
|---|---|---|---|---|
| | organic- | Thickness of | | |
| | inorganic hybrid | polyarylate | | |
| | coating layer | coating layer | | Total |
| | (μm) | (μm) | Rᵢₙ(nm) | Rₜₕ(nm) |
| Comparative | 0 | 0 | 2 | −59 |
| Example 1 | | | | |
| Comparative | 1.5 | 0 | 2 | −60 |
| Example 2 | | | | |
| Example 10 | 1.5 | 0.5 | 2 | −66.6 |
| Example 11 | 1.5 | 1.0 | 2 | −100.7 |

### EXAMPLE 12˜EXAMPLE 15

Compensator films were prepared by the same manner as described in Example 151, except that polynorbornene was used instead of polyarylate, and then optical retardation was measured. The polynorbornene used in those examples was composed of butyl group and ethyl group at the ratio of 50:50, and had molecular weight of 130,000 g/mol.

TABLE 5

| | Thickness of | | | |
|---|---|---|---|---|
| | organic- | | | |
| | inorganic hybrid | Thickness of | | |
| | coating layer | polymer coating | Rᵢₙ | Total Rₜₕ |
| | (μm) | layer (μm) | (nm) | (nm) |
| Comparative | 0 | 0 | 2 | −59 |
| Example 1 | | | | |
| Comparative | 1.5 | 0 | 2 | −60 |
| Example 2 | | | | |
| Example 12 | 1.5 | 0.5 | 2 | −73 |
| Example 13 | 1.5 | 1.5 | 2 | −75 |
| Example 14 | 1.5 | 4.5 | 2 | −81 |
| Example 15 | 1.5 | 7 | 2 | −95 |

### INDUSTRIAL APPLICABILITY

The compensator film having multilayer structure of the present invention maximizes efficiency by separately regulating different functions of each layer, secures wide view optical angle for LCD by substituting optical retardation film by taking advantage of stretching and can be used as type C (negative birefringence) compensator film by regulating optical retardation in out of plane direction owing to the double coating with organic or organic/inorganic hybrid composition and polymer.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

1. A compensator film for LCD comprising:
polymer base layer;
protective layer prepared by coating at least one side of the polymer base layer with organic or organic/inorganic hybrid composition; and
polymer coating layer formed on top of the protective layer placed on the polymer base layer, which has negative optical retardation in out of plane direction defined as the following formula 1.
$${R}_{th} = ( {n}_{z} - \frac{{n}_{x} + {n}_{y}}{2} ) \times d \qquad [ Mathematical Formula 1 ]$$
Wherein, n_{z} indicates a reflective index in out of plane direction of film, nₓ and n_{y} indicate reflective indices in in-plane direction of film, d indicates a film thickness and Rₜₕ indicates the optical retardation in out of plane direction.

2. The compensator film for LCD as set forth in claim 1, wherein the polymer base layer is made from polymer selected from a group of consisting of polycarbonate, triacetylcellulose, cyclo-olefin polymer, cyclo-olefin copolymer and (meth)acrylate polymer or an optically uniform and transparent polymer film on which one or more of the above compounds are laminated.

3. The compensator film for LCD as set forth in claim 1, wherein the thickness of the polymer base layer is 10˜300 μm.

4. The compensator film for LCD as set forth in claim 1, wherein the polymer base layer has negative optical retardation up to 200 nm in out of plane direction defined as the above formula 1.

5. The compensator film for LCD as set forth in claim 1, wherein the polymer base layer has positive optical retardation at least 20 nm in the in-plane direction defined as the following formula 2.
Rᵢₙ=(nₓ−n_{y})×d [Mathematical Formula 2]
Wherein, Rᵢₙ indicates an intrafacial optical retardation of a film, nₓ indicates a reflective index in optical axis direction of a film, n_{y} indicates reflective index at a right angle to optical axis of a film and d indicates a thickness of a film.

6. The compensator film for LCD as set forth in claim 1, wherein the organic/inorganic hybrid composition is a mixture comprising organic silane, metal alkoxide water and filler.

7. The compensator film for LCD as set forth in claim 6, wherein the organic silane is included in amount of 20˜99.99 weight part based on 100 weight part of the whole composition.

8. The compensator film for LCD as set forth in claim 6, wherein the metal alkoxide is included in amount of 20˜70 weight part based on 100 weight part of the whole composition.

9. The compensator film for LCD as set forth in claim 1, wherein the organic protective layer is made from monomer group having UV hardened or heat hardened acrylate, methacrylate and acrylate/methacrylate.

10. The compensator film for LCD as set forth in claim 1, wherein the organic/inorganic hybrid composition is a resin composition that is characterized by being able to be UV hardened or heat hardened and including a hardening catalyst and an acrylic resin selected from a group consisting of silica-dispersed oligomer solution of organic silane produced by the partial-hydrolysis of hydrolyzed organic silane from colloidal silica dispersed in organic solvent, water or a mixture thereof, acrylate oligomer, methacrylate oligomer and acrylate/methacrylate oligomer.

11. The compensator film for LCD as set forth in claim 1, wherein the organic/inorganic hybrid composition contains silicone oligomer solution having at least two acrylate functional groups obtained from hydrolysis of silicone coupling agent and oil colloid silica which are able to be UV-hardened or heat-hardened, acrylate oligomer solution, acrylate monomer solution and photo-initiator and/or thermal initiator.

12. The compensator film for LCD as set forth in claim 1, wherein the protective layer is 0.01˜10 μm in thickness.

13. The compensator film for LCD as set forth in claim 1, wherein the polymer coating layer is polyarylate coated with the thickness up to 10 μm and having negative optical retardation at least 10 nm defined as the above formula 1.

14. The compensator film for LCD as set forth in claim 1, wherein the film characteristically has negative optical retardation at least 10 nm in thickness direction defined as the above formula 1.

15. The compensator film for LCD as set forth in claim 1, wherein the total film is 20˜300 μm in thickness.

16. The compensator film for LCD as set forth in claim 13, wherein the polyarylate is a polymer represented by the following formula 1. 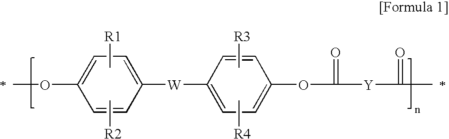
Wherein, R1, R2, R3 and R4 are independently hydrogen, C₁˜C₁₂ alkyl, C₆˜C₁₂ arylalkyl, C₆˜C₁₂ aryl, C₁˜C₁₂ nitrile, C₁˜C₁₂ alkoxy, C₁˜C₁₂ acyl or halogen, W is C₁˜C₃₀ alkylidene, C₂˜C₃₀ alkylene, C₃˜C₃₀ cycloalkylidene, C₃˜C₃₀ cycloalkene or C₁˜C₃₀ phenyl-substituted alkylene, fluorene, oxygen, sulfur, sulfoxide, sulfone or single bond.
And, —OOCYCO— can be one of terephthalic acid, isophthalic acid, dibenzoic acid or naphthalene dicarboxylic acid in which aromatic group can be substituted with a substituent selected from a group consisting of C₁˜C₈ alkyl, aryl, alkylaryl and halogen, and/or a mixture comprising at least two of the above.

17. The compensator film as set forth in claim 13, wherein weight average molecular weight of the polyarylate is at least 20,000 g/mol.

18. A LCD comprising the compensator film of claim 1.

19. The LCD as set forth in claim 18, which is selected from a group consisting of vertical alignment LCD, twist nematic LCD and sheet switching LCD.

20. The LCD as set forth in claim 18, wherein the LCD is vertical alignment LCD.

21. The compensator film for LCD as set forth in claim 2, wherein the thickness of the polymer base layer is 10˜300 μm.

22. The compensator film for LCD as set forth in claim 2, wherein the polymer base layer has negative optical retardation up to 200 nm in out of plane direction defined as the above formula 1.

23. The compensator film for LCD as set forth in claim 2, wherein the polymer base layer has positive optical retardation at least 20 nm in the in-plane direction defined as the following formula 2.
Rᵢₙ=(nₓ−n_{y})×d [Mathematical Formula 2]
Wherein, Rᵢₙ indicates an intrafacial optical retardation of a film, nₓ indicates a reflective index in optical axis direction of a film, n_{y} indicates reflective index at a right angle to optical axis of a film and d indicates a thickness of a film.
